(19) United States
(12) Patent Application Publication
(10) Pub. No.: US 2009/0294601 A1
(43) Pub. Date: Dec. 3, 2009

(54) Mounting Clamp For A Floor Heating System

(76) Inventors: Asker Hojlund Pedersen, Mariager (DK); Torben Dejligbjerg, Mariager (DK)

Correspondence Address: WILLIAM J. SAPONE;COLEMAN SUDOL SAPONE P.C., 714 COLORADO AVENUE, BRIDGE PORT, CT, 06605, US

(21) Appl. No.: 12/300,141

(22) PCT Filed: Jun. 7, 2007
(86) PCT No.: PCT/DK07/00272

§ 371 Date: Mar. 13, 2009

(30) Foreign Application Priority Data
Jun. 9, 2006 (DK) BA200600166
Sep. 6, 2006 (DK) PA200601146
Jan. 16, 2007 (DK) BA200700012

(51) Int. Cl. F16L 3/08

(52) U.S. Cl. 248/74.1

(57) ABSTRACT

When according to the invention, a mounting clamp (1) for a floor heating system and for mounting on a reinforcement net is constructed such that is comprises a frame (2) on a foot plate (9) as well as means for gripping and securing a pipe or cable-like heat generator to the mounting clamp (1) and to the reinforcement net, and the frame (2) is provided with a means in the form of a substantially horizontally extending incision (3) having a locking pawl (4) for receiving a wire from the reinforcement net, it is ensured that the mounting clamp may be snapped on to the reinforcement net in one movement. When the frame (2) is additionally provided with a means in the form of a funnel (15) having an upwardly directed mouth with guide plates (18,19) and with a locking pawl (17), it may advantageously be used for electrical heating cables.

### THE PRIOR ART

The invention relates to a mounting damp, in particular for a floor heating system, and for mounting on a reinforcement net, which comprises a frame, a foot plate as well as means for gripping and securing a pipe or cable-like heat generator to the mounting damp and means for securing the mounting clamp to the reinforcement net, and wherein the means tor gripping and securing the pipe or cable-like heat generator comprise a substantially upwardly extending opening, and wherein the means for securing the mounting clamp to the reinforcement net comprise a substantially horizontally extending Incision, said incision being funnel-shaped and equipped with an upper guide plate and a lower guide plate which are directed inwards toward a seat for a wire, and wherein the lower guide plate extends with e slightly upwardly rising inclination from the front edge of the foot plate at the mouth of the incision and forwards to the seat, and that the incision additionally is equipped with a locking pawl.

Floor heating systems are frequently used in new built houses or are provided in connection with a renovation of heating systems in older houses and basements. The floor heating system is constructed by placing a capillary interrupting layer on the ground and placing a layer of concrete thereon. Then, insulation bat, or blocks are placed on the concrete layer in order to reduce the heat distribution downwards. A reinforcement net is placed above the insulation on a number of blocks in order to create spacing to the insulation bats, so that the reinforcement net will be disposed centrally in the upper concrete layer, thereby making room for a reasonable concrete thickness below the net, but also in order to create a base for the attachment of the floor heating coils. When the floor heating coils have been placed, the upper concrete layer is applied and smoothed.

The floor heating coils are laid in large loops so that the distance between the various leaps is in the vicinity of 30 cm. In order to secure the coils during laying and during casting, the coils are secured to the reinforcement net. Generally, the coils are secured manually by strips or steel wire.

A second method of securing the coils is described in the published document WO 2006/029627, in which a mounting clamp is used, configured to be placed in the wire intersections on a reinforcement net. The mounting clamp is relatively high and slender, and it must be assumed that it may be problematic, to make the heating cells He stably, because the coils are not supported between the clamps, and also because the supporting faces of the clamps are relatively small.

A third method of securing floor heating coils is described in the document FR 2700349 A1, which discloses a mounting clamp for heating coils for floor heating systems, which comprises arms for gripping the heater coil. The arms are mounted on a frame which is equipped with an opening for receiving a wire from a reinforcement net, said opening being adapted to secure the mounting clamp with a locking element. The opening is oriented in a vertical direction, so that the mounting clamp may be mounted by pressing the holder downwards towards the reinforcement net. Moreover, the opening is adapted to receive up to two reinforcement nets disposed above each other, only the upper one of which being secure by the locking element. On the face of it, the frame appears to be too fragile for the task, and the frame does not have large tread fare.

A fourth mounting is described in Danish Patent DK 174344, which discloses a clamp provided with a horizontally extending incision having a plurality of depressions for receiving a wire from the reinforcement net. The clamp is locked to the reinforcement net by pressing a heating pipe down into the depression provided for the purpose, whose one arm is so flexible as to deflect when the pipe is introduced. The configuration of the clamp does not appear to be expedient, and must be assumed to cause problems in the mounting.

The patent DE 4304698 A1 discloses a mounting clamp, which is constructed on the basis of a circular foot member. The foot member is formed with a horizontally disposed funnel having guide plates which lead into a seat for a wire, the upper guide plate of which being configured as a locking pawl. The clamp is mounted by placing the clamp above the wire by means of a mounting stick and then rotating the clamp 45 degrees to the one or the other side. The structure shown is complex and requires sophisticated plastics moulding tools, and, therefore, it must be assumed that the production costs are somewhat higher than for the mounting clamp according to the invention. The position of the wire and the distance from the base and to the seat of the wire seem to be insufficient if there is to be room for a reasonable amount of concrete below the net, in order to avoid cracking caused by loading or corrosion.

The document DE 3229971 A1 discloses a detachable attachment element, which is configured as a band-like clamp whose open side points downwards to embrace a pipe, and wherein the two ends of the band is equipped with retaining means for connecting to the reinforcement net. The clamp is designed to be pre-mountable on the pipe-coils prior to being laid down, and must be pre-mounted on the pipe-coils from the end of the pipe like pearls on a string. The work involved with this clamp is not attractive. It is time consuming and troublesome because the pipe-coils are heavy and very stiff.

An additional method of laying and securing floor heating coils is shown on the Uponor and Wirsbo homepage: www.wirsbo.dk. It is shown there how the coils are laid in a mounting band placed directly on the insulation bats, and that the reinforcement net is then laid on top of the coils, following which casting takes place. Here, the coils are not secured to the reinforcement net.

The work involved by the laying of the heating coils and tying them firmly to the reinforcement net by strips or metal wire, is cumbersome and time-consuming and involves an extreme strain on the knees and the back, because the coils are to be unrolled and laid while being tied to the reinforcement net. The rolls are heavy and cumbersome to handle. In addition, it is a problem to walk on the net which yields and deflects because of the assembly on blocks.

In addition, it may give rise to problems if the coils are tied tightly and firmly to the reinforcement net. In operation, the coils will be heated and cooled regularly. The expansions of the material may then cause leaks on the coils in the areas where they are tied because of the wear against the reinforcement net.

The above mentioned techniques for securing and embedding heating coils and cables also find application in the laying of hoses for water supply. Here, however, also an outer hose is used for the protection of the water hose.

### THE OBJECT OF THE INVENTION

The object of the invention is to remedy the above-mentioned drawbacks and to improve mounting clamps for pipe or cable-like heat generators to the greatest extent possible, and this is achieved by configuring the lower guide plate as a locking pawl at its most remote end opposite the mouth of the incision and is moreover configured such that it extends forwards in front of the upper guide plate, which upper guide plate extends substantially horizontally from the mouth of the incision and forwards to the seat, and is provided with a bend directed outwardly relative to the mouth of the incision.

In this surprisingly simple manner, a mounting clamp is achieved, which can stand stably on the base without turning over because of the size and the shape of the frame and the foot plate, and which may be snapped on to the reinforcement net in one horizontally extending movement, whereby the wire is caught by the incision and is guided by the guide plates forwards to the seat, where the wire is secured by the seat and the locking pawl in combination.

The movement of the mounting clamp above the base is controlled and supported by the foot plate and is implemented by pressing on the pressure plate, which is arranged on the rear edge of the frame. Then, the necessary number of clamps may be arranged quickly, and subsequently the heat generator is pressed into position in the means for securing the heat generator by the foot. Further, the reinforcement net and the heat generator are separated, so that the heat generators are not subjected to wear at the tying points.

When, as stated in claim 2, the mounting clamp is equipped with securing means for a pipe or cable-like heat generator, said securing means being configured as a pipe depression between a set of arms, it is ensured that the clamp may secure pipes or cables of different sizes.

When, as stated in claim 3, the mounting clamp is equipped with securing means for a pipe or cable-like heat generator, said securing means being configured as a funnel with an upwardly directed mouth and with sides pointing inwards and downwards towards a seat behind a locking pawl, it is ensured that electrical heating cables may be laid and secured.

When, as stated in claim 4, the centre of the seat is arranged at a distance from the bottom of the foot plate, spacing is advantageously provided between the insulation and the reinforcement net, so that the net will be disposed more centrally in the concrete layer so as to stabilize the concrete floor as best as possible. When the seat is additionally given a circular arc-shaped cross-section of a diameter corresponding to the wire diameter of the reinforcement net and a length corresponding to the width of the foot plate, it is ensured that the mounting clamp may be mounted safely on a reinforcement net having a corresponding wire diameter

When, as stated in claim 5, the locking pawl is configured so that it is resilient at the free end, and so that, over a distance which at least constitutes one-half the length of the locking pawl, it is configured with a dimension in the width corresponding to the width of the foot plate, it is ensured on the one hand that a reinforcement wire may be pressed past the locking pawl and into the seat in the application, and on the other hand that a mounting clamp which is placed wrongly may be released by pressing the locking pawl aside, and when additionally the free end of an engagement face is configured with a radius of curvature which corresponds to the radius of curvature of the seat, it is ensured that a wire from the reinforcement net may be locked and secured in a safe and expedient manner.

When, as stated in claim 6, the frame is constructed as a structure of connected ribs with intermediate transversely arranged body plates and with guide plates, pressure plate, foot plates and arms as stiffening elements, a rigid and stable mounting clamp is achieved, which is capable of withstanding tension and torsion from the heat generators during laying.

Finally, as stated in claims 7 and 8, it is expedient to make the mounting clamp with the stated dimensions and materials, so that the stability and heating capacity requirements may be satisfied.

### THE DRAWING

An example of an embodiment according to the invention will be described more fully below with reference to the drawing, in which

FIG. 1 shows the mounting clamp according to the invention, seen from the side,

FIG. 2 shows a perspective view of the mounting clamp according to the invention, seen obliquely from above,

FIG. 3 shows a perspective view of the mounting clamp according to the invention, seen obliquely from below, and

FIG. 4 shows a side view of a mounting clamp with a securing means for heating cables.

### DESCRIPTION OF AN EXEMPLARY EMBODIMENT

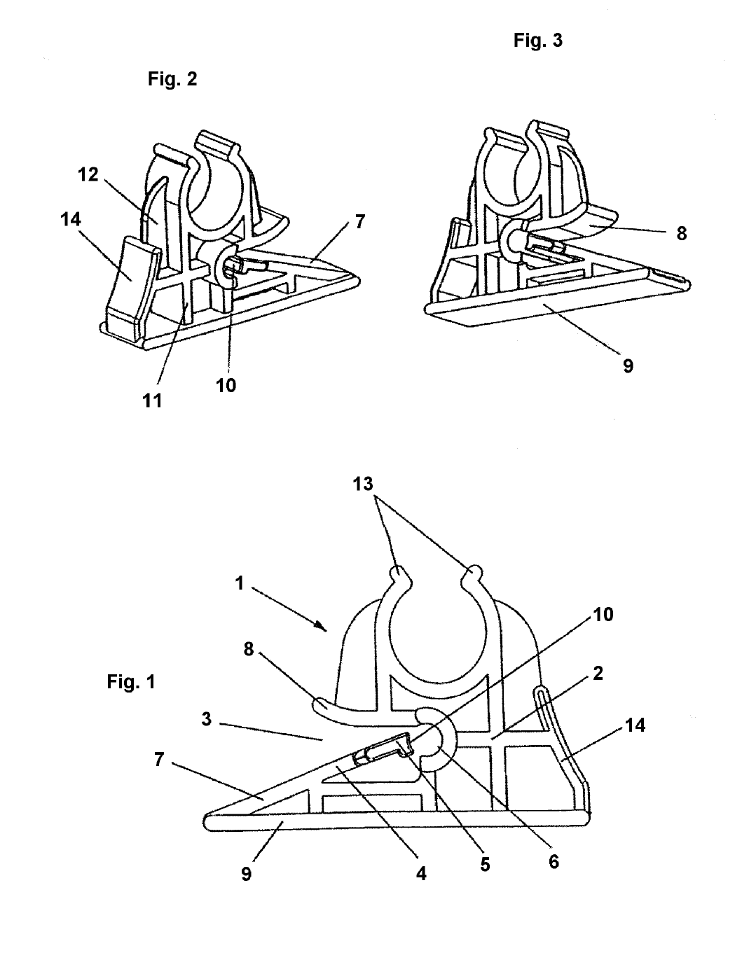

FIG. 1 shows a side view of the mounting clamp 1 according to the invention. It will be seen in the figure that the mounting clamp is provided with a pipe depression having arms 13, which are configured to grip a pipe or cable-like heat generator. The arms 13 are built together with and placed centrally above the frame 2, which stands on the foot plate 9.

The frame 2 is provided with a substantially horizontally extending incision 3 for receiving a wire from the reinforcement net. Opposite the incision 3, the frame is additionally equipped with a pressure plate 14 which is used in the mounting of the mounting clamp. The incision 3 is funnel-shaped and is provided with lower and upper guide plates 7, 8, which define the funnel and point inwards toward the centre of the frame to a seat 6 for the wire.

The lower guide plate 7 extends with a slightly upwardly rising inclination from the front edge of the foot plate 9 at the mouth of the incision 3 and forwards to the seat 6, and is configured as a resilient locking pawl 4 at its most remote end opposite the mouth of the incision. The upper guide plate 8 extends substantially horizontally from the mouth of the incision and forwards to the seat 6 and is additionally provided with a bend directed outwardly relative to the mouth of the incision. The course of the guide plates makes it an easy matter to catch a wire on the reinforcement net and guide it into the seat.

FIGS. 1, 2 and 3 show that the guide plate 7 is configured as the locking pawl 4. However, the guide plate 8 might equally be configured as a locking pawl, and both embodiments are therefore comprised by the invention.

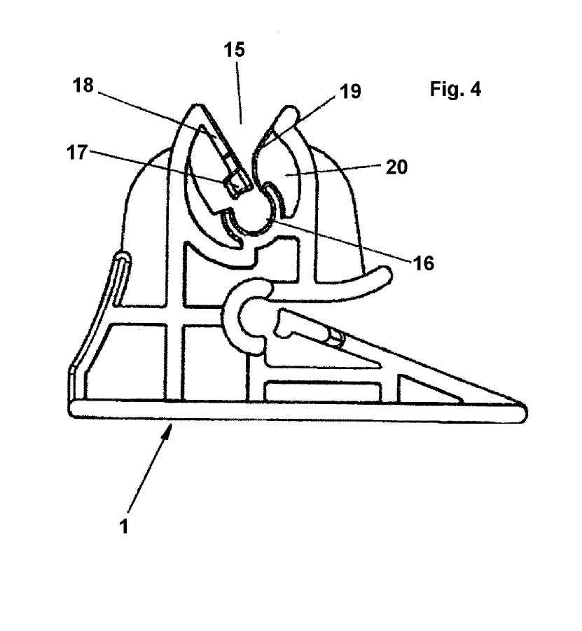

FIG. 4 shows a variant of a means for securing a pipe or cable-like heat generator. The means is configured as a funnel 15 with an upwardly directed mouth whose sides 18, 19 point inwards and down to a seat 16 behind a locking pawl 17. The side 18 is configured as a flexible guide plate, where the free end forms the locking pawl 17. The other side 19 is formed by the edge of the body plate 20. This means may be released by pressing on the thickenings of the locking pawl 17 and pressing the pawl aside. A heating cable is easily mounted by pressing it into the funnel 15 and down into the seat 16 behind the locking pawl 17.

In FIG. 1, the looking pawl 4 is configured with a free end 5 which is flexible and the free end will therefore deflect when a wire from the reinforcement net is pressed in. The outer half of the free and 5 is configured with a larger dimension in the width than the other half, so that it is possible to affect the locking pawl by the fingers—a possibility which might be useful if a mounting clamp is to be removed for some reason. Moreover, the free end is provided with an engagement face 10 which is configured with a radius of curvature corresponding to the radius of curvature of the seat 6.

The seat 6 is intended to receive a wire from the reinforcement net and secure it together with the locking pawl 4. For this purpose, the seat is configured as a portion of a circular arc. The circular arc of the seat may be configured with radii of curvature from 2 to 6 mm.

The centre of the circular arc of the seat is positioned at a distance above the bottom of the foot plate 9. The distance is determined by the dimensions of the wire diameter of the reinforcement net, the diameter of the heat generator and the desired thickness of the concrete layer, and forms the basis for the selection of the size of the mounting clamp.

The distance from the bottom of the foot plate 9 to the centre of the circular arc of the seat may be from 16 to 20 mm. This distance is important in order to ensure that the concrete layer above the insulation, but below the reinforcement net, always has a thickness and thereby strength so that it does not crack when loaded or by heat impacts in operation.

The mounting clamp 1 is moulded of plastics, and the frame 2 is constructed as a rib structure with transversely arranged body plates for stiffening between the ribs. The guide plates 7, 8, the pressure plate 14, the foot plate 9 and the arms 13 are likewise incorporated as stiffening elements or ribs. This structure results in a very rigid and sturdy mounting clamp with a minimum consumption of materials. The foot plate 9 is configured with the purpose of creating a stable engagement face against the base and is dimensioned so suitably large that the clamp does not turn over because of the forces that are produced when the heat generators are placed in a loop.

The arms 9 are provided with outer projecting ends configured to catch a pipe, a cable or a hose. The arms are moreover supported by ribs and body plates. The frame 2 is provided with a pressure plate 14 which is positioned opposite the opening 3, and which is used in the mounting of the mounting clamp.

Mounting of the mounting clamp 1 on a reinforcement net is performed by applying the clamp to the insulation at a reinforcement wire with the opening 3 facing toward the wire. Then, the clamp 1 is moved toward the wire by a pressure on the pressure plate 14 until the wire is completely into the seat 6, and the locking pawl 4 blocks the wire.

Dismounting of a mounting clamp takes place by forcing the locking pawl 4 aside by pressing the wide area of the free end 5 of the locking pawl. The clamp is then pulled away from the wire.

Of course, the mounting clamp 1 may be used in connection with the laying of flexible pipes or cables for heating, but also for pipes or hoses for water supply.

1. A mounting clamp, in particular for a floor heating system, and for mounting on a reinforcement net, comprising a frame (2), a foot plate (9), means for gripping and securing a pipe or cable-like heat generator to the mounting clamp (1) and means for securing the mounting clamp to the reinforcement net, and wherein the means for gripping and securing the pipe or cable-like heat generator comprise a substantially upwardly extending opening, and wherein the means for securing the mounting clamp to the reinforcement net comprise a substantially horizontally extending incision (3), said incision (3) being funnel-shaped and equipped with an upper guide plate (8) and a lower guide plate (7) which are directed inwards toward a seat (6) for the wire, and wherein the lower guide plate (7) extends with a slightly upwardly rising inclination from the front edge of the foot plate (9) at the mouth of the incision (3) and forwards to the seat (6), and wherein the incision (3) additionally is equipped with a locking pawl (4), the lower guide plate (7) being additionally configured as the locking pawl (4) at its most remote end opposite the mouth of the incision, and which is moreover configured such that the lower guide plate extends forwards in front of the upper guide plate (8), the upper guide plate (8) extending substantially horizontally from the mouth of the incision and forwards to the seat (6), and being provided with a bend directed outwardly relative to the mouth of the incision.

2. A mounting clamp according to claim 1, characterized in that the means for securing a pipe or cable-like generator are configured as a pipe depression in order to receive pipes or cables of a diameter from 10 to 30 mm between the arms (13).

3. A mounting clamp according to claim 1, characterized in that the means for securing a pipe or cable-like heat generator are configured as a funnel (15) having an upwardly directed mouth, whose sides (18, 19) point downwards and inwards toward a seat (16) behind a locking pawl (17), and wherein the side (18) is configured as a guide plate which is flexible, and wherein the free end of the plate forms the locking pawl (17), and wherein the side (19) is formed by the edge of the body plate (20).

4. A mounting clamp according to claim 1, characterized in that the centre of the seat (6) is arranged at a distance from the bottom of the foot plate (9), and that the seat is additionally shaped as a circular arc and is configured with a length corresponding to the width of the foot plate (9) and a diameter corresponding to the wire.

5. A mounting clamp according to claim 4, characterized in that the locking pawl (4) comprises a resilient free end (5), and that, over a distance which at least constitutes one half of the locking pawl, it is configured with at least a dimension in the width corresponding to the width of the foot plate (9), and that it is additionally configured with an engagement face (10) having a radius of curvature which corresponds to the radius of curvature of the seat (6).

6. A mounting clamp according to claim 1, characterized in that the frame (2) is constructed as a structure of connected ribs (11) with intermediate transversely arranged body plates (12), and wherein each rib (14) is moreover a pressure plate, and wherein the guide plates (7, 8), the pressure plate (14), the foot plate (9) and the arms (13) also form stiffening elements.

7. A mounting clamp according to claim 1, characterized in that the length of the foot plate (9) is typically from about 6 to 12 cm, and that the length is 3 to 6 times larger than the width.

8. A mounting clamp according to claim 1, characterized in that it is made of plastics.

9. A mounting clamp according to claim 4, characterized in that the length of the foot plate (9) is typically from about 6 to 12 cm, and that the length is 3 to 6 times larger than the width.

10. A mounting clamp according to claim 5, characterized in that the length of the foot plate (9) is typically from about 6 to 12 cm, and that the length is 3 to 6 times larger than the width.

11. A mounting clamp according to claim 6, characterized in that the length of the foot plate (9) is typically from about 6 to 12 cm, and that the length is 3 to 6 times larger than the width.
